(19) United States
(12) Patent Application Publication
(10) Pub. No.: US 2024/0085112 A1
(43) Pub. Date: Mar. 14, 2024

(54) HEAT TREATMENT SYSTEM

(71) Applicants: NGK INSULATORS, LTD., Nagoya-Shi (JP); NGK KILNTECH, CORPORATION, Nagoya-Shi (JP)

(72) Inventors: Masashi TANAMURA, Nagoya-Shi (JP); Tomoaki OYAMA, Nagoya-Shi (JP); Takanori ISONO, Nagoya-Shi (JP)

(73) Assignees: NGK INSULATORS, LTD., Nagoya-Shi (JP); NGK KILNTECH, CORPORATION, Nagoya-Shi (JP)

(21) Appl. No.: 18/460,744

(22) Filed: Sep. 5, 2023

(30) Foreign Application Priority Data
Sep. 8, 2022 (JP) 2022-143096

(51) Int. Cl. F27B 9/24; F27B 9/39

(52) U.S. Cl. CPC F27B 9/24; F27B 9/39

(57) ABSTRACT

A heat treatment system may include a heat treatment furnace configured to heat treat a material in a saggar; a conveyor configured to convey the saggar from an exit to an entrance of the heat treatment furnace; a recovery apparatus configured to recover the material heat-treated from the saggar; and a supply device configured to supply a non-heat treated material to the saggar. The conveyor may include a conveyor mechanism and a drive unit configured to drive the conveyor mechanism. The recovery apparatus may comprise a recovery unit disposed at a position where the conveyor mechanism is not disposed and configured to recover the material in the saggar; a transport device configured to transport the saggar between a placement position on the conveyor mechanism and a recovery position above the recovery unit; and an inversion mechanism configured to invert the saggar at the recovery position.

### CROSS-REFERENCE TO RELATED APPLICATION

The present application claims priority to Japanese Patent Application No. 2022-143096, filed on Sep. 8, 2022, the entire contents of which are incorporated herein by reference.

### TECHNICAL FIELD

The technology disclosed herein relates to a technology for heat treating a material.

### BACKGROUND ART

Heat treatment furnaces (e.g., roller hearth kilns, pusher kilns, etc.) may be used to heat treat materials. For example, in order to heat treat a material such as powder in a heat treatment furnace, the material is put in a saggar for heat treatment. After the heat treatment, the saggar is inverted to recover the heat-treated material. For example, Japanese Patent No. 7041300 describes a heat treatment system including a heat treatment furnace and a recovery apparatus that recovers a heat-treated material after heat treatment. The recovery apparatus of Japanese Patent No. 7041300 includes conveyor rollers that convey a saggar, a recovery unit that recovers a heat-treated material in the saggar, and an inversion mechanism that inverts the saggar. The recovery unit is located below the conveyor rollers. The inversion mechanism is configured to invert both the plurality of conveyor rollers located above the recovery unit and the saggar placed on those conveyor rollers together. Once the saggar is conveyed to above the recovery unit, the saggar is inverted, together with the plurality of conveyor rollers, by the inversion mechanism. As a result, the heat-treated material in the saggar falls down and is recovered into the recovery unit located below.

### DESCRIPTION

### Summary

In the recovery apparatus of Japanese Patent No. 7041300, the conveyor rollers are inverted together with the saggar when the saggar is inverted, and thus the total weight to be inverted is large. Therefore, it is difficult to increase the inversion speed. As a result, it takes a long time to recover the heat-treated material.

The disclosure herein provides a technology that can reduce a time required to recover a heat-treated material after heat treatment.

According to a first embodiment of the technology disclosed herein, a heat treatment system may comprise a heat treatment furnace including an entrance and an exit, and configured to heat treat a material in a saggar while the saggar is conveyed from the entrance to the exit; a conveyor configured to convey the saggar that exited from the exit of the heat treatment furnace to the entrance of the heat treatment furnace; a recovery apparatus disposed on a conveying path of the conveyor and configured to recover the material heat-treated in the heat treatment furnace from the saggar; and a supply device disposed on the conveying path of the conveyor between the recovery apparatus and the entrance, and configured to supply a non-heat treated material to the saggar that does not contain the material. The conveyor may comprise a conveyor mechanism disposed along the conveying path; and a drive unit configured to drive the conveyor mechanism. The conveyor may be configured to convey the saggar placed on the conveyor mechanism by the drive unit driving the conveyor mechanism. The recovery apparatus may comprise a recovery unit disposed at a position where the conveyor mechanism is not disposed and configured to recover the material in the saggar; a transport device configured to transport the saggar between a placement position on the conveyor mechanism and a recovery position above the recovery unit; and an inversion mechanism configured to invert the saggar at the recovery position.

### BRIEF DESCRIPTION OF DRAWINGS

FIG. 1 is a schematic top view of a heat treatment system according to first and second embodiments.

FIG. 2 is a block diagram showing a control system of the heat treatment system according to the first and second embodiments.

FIG. 3 is a schematic diagram of a heat treatment furnace in a longitudinal cross-sectional view along a plane parallel to a conveying direction of a saggar.

FIG. 4 is a cross-sectional view along a line IV-IV in FIG. 3.

FIG. 5A is a top view of a recovery apparatus according to the first embodiment, where a saggar is at a placement position.

FIG. 5B is a top view of the recovery apparatus according to the first embodiment, where the saggar is at a recovery position.

FIG. 6A is a side view of the recovery apparatus according to the first embodiment, where the saggar is at the placement position.

FIG. 6B is a side view of the recovery apparatus according to the first embodiment, where the saggar is above the placement position.

FIG. 6C is a side view of the recovery apparatus according to the first embodiment, where the saggar is at the recovery position.

FIG. 7 is a side view of a hood according to the first embodiment as viewed in a direction perpendicular to the conveying direction.

FIG. 8 is a side view showing the hood, a brush, a suction device, and a dust collecting duct.

FIG. 9A is a top view of a recovery apparatus according to the second embodiment, where a saggar is on entrance-side conveyor rollers.

FIG. 9B is a top view of the recovery apparatus according to the second embodiment, where the saggar is positioned above a recovery unit.

FIG. 9C is a top view of the recovery apparatus according to the second embodiment, where the saggar is on exit-side conveyor rollers.

FIG. 10A is a side view of the recovery apparatus according to the second embodiment, where a saggar is lifted by lifting pins above the entrance-side conveyor rollers.

FIG. 10B is a side view of the recovery apparatus according to the second embodiment, where the saggar is positioned above the recovery unit.

FIG. 10C is a side view of the recovery apparatus according to the second embodiment, where the saggar is lifted by lifting pins above the exit-side conveyor rollers.

FIG. 11 is a side view of a hood according to the second embodiment as viewed in the conveying direction.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment systems, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a first embodiment of the technology disclosed herein, a heat treatment system may comprise a heat treatment furnace including an entrance and an exit, and configured to heat treat a material in a saggar while the saggar is conveyed from the entrance to the exit; a conveyor configured to convey the saggar that exited from the exit of the heat treatment furnace to the entrance of the heat treatment furnace; a recovery apparatus disposed on a conveying path of the conveyor and configured to recover the material heat-treated in the heat treatment furnace from the saggar; and a supply device disposed on the conveying path of the conveyor between the recovery apparatus and the entrance, and configured to supply a non-heat treated material to the saggar that does not contain the material. The conveyor may comprise a conveyor mechanism disposed along the conveying path; and a drive unit configured to drive the conveyor mechanism. The conveyor may be configured to convey the saggar placed on the conveyor mechanism by the drive unit driving the conveyor mechanism. The recovery apparatus may comprise a recovery unit disposed at a position where the conveyor mechanism is not disposed and configured to recover the material in the saggar; a transport device configured to transport the saggar between a placement position on the conveyor mechanism and a recovery position above the recovery unit; and an inversion mechanism configured to invert the saggar at the recovery position.

In the above heat treatment system, the recovery unit is disposed at a position where the conveyor mechanism is not disposed, and thus the saggar is transported from on the conveyor mechanism to above the recovery unit before being inverted. In other words, the conveyor mechanism is not interposed between the saggar and the recovery unit when the saggar is inverted. Therefore, the conveyor mechanism (e.g., conveyor rollers) is not inverted together with the saggar. Only the saggar can be inverted above the recovery unit, and thus it is possible to avoid an increase in the overall weight to be inverted. This allows the inversion speed to be increased, thereby reducing a time required to recover the heat-treated material.

In a second embodiment of the technology disclosed herein according to the first embodiment, the inversion mechanism may comprise a grip unit configured to grip the saggar and may be configured to invert the saggar by the grip unit rotating about a rotation axis while gripping the saggar. The transport device may be configured to transport the inversion mechanism with the grip unit gripping the saggar between the placement position on the conveyor mechanism and the recovery position above the recovery unit. According to this configuration, the inversion mechanism is transported to the recovery position above the recovery unit while gripping the saggar. The saggar is inverted by the grip unit rotating about the rotation axis while gripping the saggar. Thus, the saggar can be appropriately inverted at the recovery position.

In a third embodiment of the technology disclosed herein according to the second embodiment, the recovery apparatus may further comprise a hood covering the recovery unit from above. The hood may be sized to accommodate the saggar and the grip unit. The grip unit may be rotatable about the rotation axis while gripping the saggar when the saggar and the grip unit are in the hood. According to this configuration, the saggar is inverted in the hood, and thus the heat-treated material is not dispersed out of the hood when the saggar is inverted.

In a fourth embodiment of the technology disclosed herein according to the third embodiment, the grip unit may comprise a pair of grip pieces configured to grip the saggar by contacting a pair of opposing side surfaces of the saggar. The inversion mechanism may further comprise a pair of supports supporting the pair of grip pieces. One end of each support may be located inside the hood and the other end thereof may be located outside the hood when the saggar and the grip unit are in the hood. The hood may comprise a first opening defined in a first side surface; and second openings defined in second side surfaces orthogonal to the first side surface. The first opening may allow the saggar to enter the hood from the first side surface. The second openings may extend along an entry direction of the saggar and allow the other ends of the supports to protrude out of the hood through the second openings when the saggar is in the hood. This configuration allows the saggar to enter the hood from the side (first side surface) of the hood while being gripped by the grip unit.

In a fifth embodiment of the technology disclosed herein according to the fourth embodiment, the inversion mechanism may further comprise first covers that cover the second openings when the saggar gripped by the grip unit is in the hood. According to this configuration, the inversion mechanism comprises the first covers, and thus the first covers move integrally with the inversion mechanism. Therefore, when the saggar enters the hood, the supports can move in the second openings, whereas when the saggar is in the hood, the first covers can cover the second openings. This prevents the heat-treated material from dispersing out of the hood through the second openings when the saggar is inverted in the hood.

In a sixth embodiment of the technology disclosed herein according to the fourth or fifth embodiment, the recovery apparatus may further comprise a second cover that opens and closes the first opening. The saggar may be allowed to pass through the first opening when the second cover opens the first opening, and the saggar may be prevented from passing through the first opening when the second cover closes the first opening. According to this configuration, the second cover can cover the first opening when the saggar is in the hood. This prevents the heat-treated material from dispersing out of the hood through the first opening when the saggar is inverted in the hood.

In a seventh embodiment of the technology disclosed herein according to any one of the first to sixth embodiments, an entrance and an exit of the recovery apparatus may be disposed on the conveying path. The conveyor mechanism may be disposed along the conveying path from the entrance of the recovery apparatus to the exit of the recovery apparatus. The recovery unit may be disposed offset from the conveying path. According to this configuration, the recovery unit is disposed offset from the conveying path, and thus the heat-treated material is recovered at a position offset from the conveying path. In other words, the saggar can be inverted at the position offset from the conveying path. This allows maintenance for the inversion mechanism and the recovery unit to be performed at the position offset from the conveying path.

In an eighth embodiment of the technology disclosed herein according to the seventh embodiment, the recovery unit may be disposed rightward or leftward of the conveying path and/or above the conveying path. According to this configuration, the recovery unit can be appropriately offset from the conveying path.

In a ninth embodiment of the technology disclosed herein according to any one of the first to sixth embodiments, the conveyor mechanism may comprise a first conveyor mechanism disposed close to an entrance of the recovery apparatus in the recovery apparatus; and a second conveyor mechanism disposed close to an exit of the recovery apparatus in the recovery apparatus. The recovery unit may be disposed between the first conveyor mechanism and the second conveyor mechanism. According to this configuration, the recovery unit is disposed between the first and second conveyor mechanisms, and thus the recovery unit is disposed on the conveying path but at a position where the conveyor mechanisms are not located.

In a tenth embodiment of the technology disclosed herein according to any one of the first to ninth embodiments, the recovery apparatus may further comprise a removal device configured to remove the material adhering to an outer surface of the saggar which is located above the recovery unit. When the saggar is inverted, the heat-treated material may adhere to the outer surface of the saggar. Since the recovery apparatus comprises the removal device, the heat-treated material adhering to the outer surface of the saggar can be removed by the removal device above the recovery unit. This prevents the heat-treated material from adhering to the conveyor mechanism (from being introduced to the conveying path).

In an eleventh embodiment of the technology disclosed herein according to any one of the third to sixth embodiments, the recovery apparatus may further comprise a suction device configured to suction gas in the hood. This configuration allows for suction of the heat-treated material floating in the air due to the saggar inversion and prevents the heat-treated material from dispersing out of the hood because a negative pressure is generated in the hood.

### EMBODIMENTS

### First Embodiment

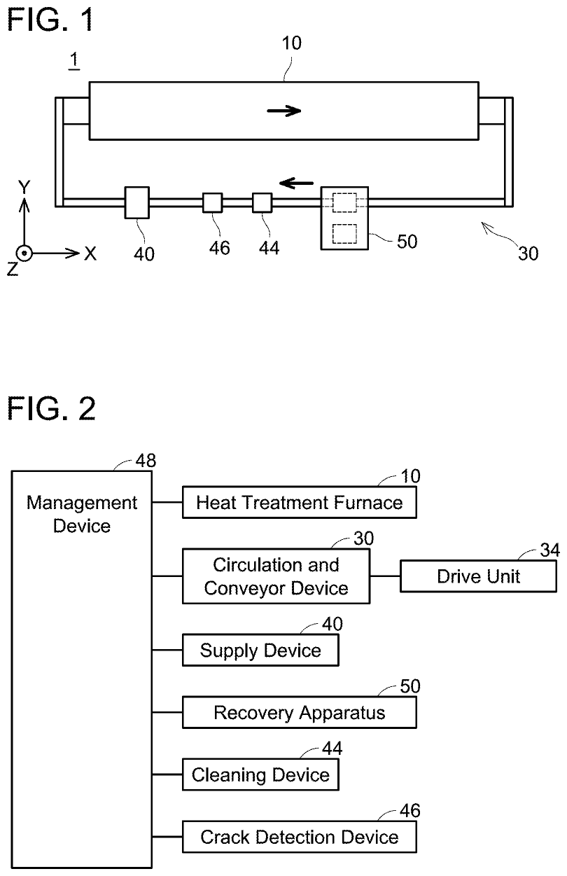

With reference to the drawings, a heat treatment system 1 according to an embodiment is described. As shown in FIGS. 1 and 2, the heat treatment system 1 comprises a heat treatment furnace 10, a circulation and conveyor device 30, a supply device 40, a recovery apparatus 50, a cleaning device 44, a crack detection device 46, and a management device 48.

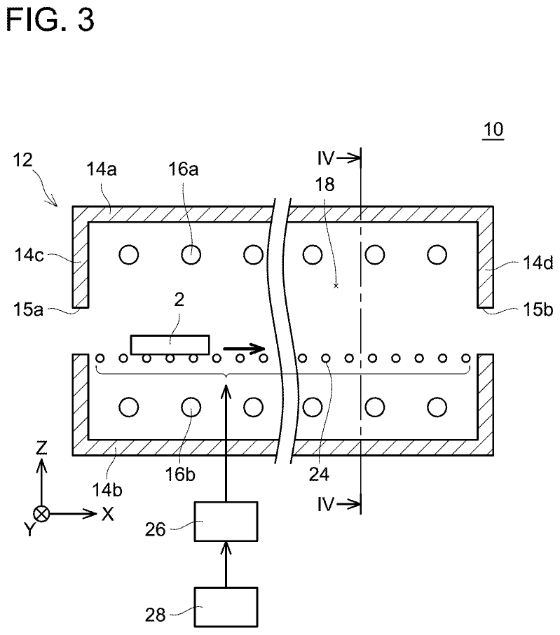

The heat treatment system 1 heat treats a material in a saggar 2 (see FIG. 3). In this embodiment, the material in the saggar 2 is powder of lithium-ion battery cathode material. In the heat treatment system 1 according to the present embodiment, the saggar 2 circulates through the supply device 40, the heat treatment furnace 10, the recovery apparatus 50, the cleaning device 44, and the crack detection device 46. The material is heat-treated while the saggar 2 is conveyed through the heat treatment furnace 10. As shown in FIG. 2, the management device 48 is connected to the heat treatment furnace 10, the circulation and conveyor device 30, the supply device 40, the recovery apparatus 50, the cleaning device 44, and the crack detection device 46. The management device 48 controls operations of the heat treatment furnace 10, the circulation and conveyor device 30, the supply device 40, the recovery apparatus 50, the cleaning device 44, and the crack detection device 46.

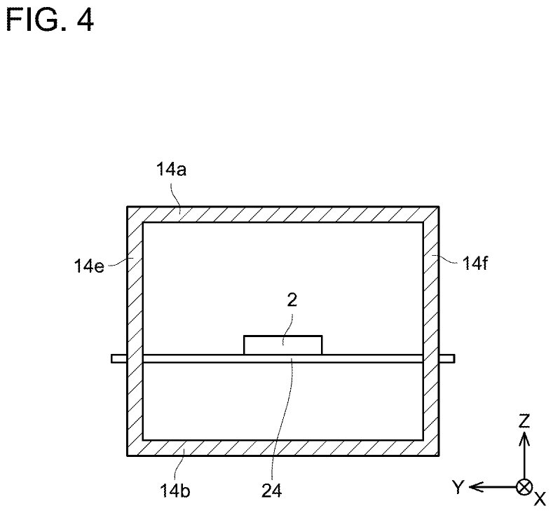

The heat treatment furnace 10 heat treats the material in the saggar 2. As shown in FIGS. 3 and 4, the heat treatment furnace 10 comprises a furnace body 12 and a conveyor (24, 26). The heat treatment furnace 10 heat treats the material in the saggar 2 while the saggar 2 is conveyed through the furnace body 12 by the conveyor (24, 26).

The furnace body 12 has an outer shape of substantially cuboid, and a heat treatment space 18 therein is defined by a ceiling wall 14a, a bottom wall 14b, a furnace entrance wall 14c, a furnace exit wall 14d, and side walls 14e and 14f. As shown in FIG. 3, the ceiling wall 14a is parallel to the bottom wall 14b (i.e., parallel to XY plane). The furnace entrance wall 14c is located at one end of a conveying path and is perpendicular to a conveying direction of the saggar 2 (hereinafter simply referred to as “conveying direction”) (i.e., parallel to YZ plane). The furnace exit wall 14d is located at the other end of the conveying path and is parallel to the furnace entrance wall 14c (i.e., parallel to YZ plane). As shown in FIG. 4, the side walls 14e and 14f are parallel to the conveying direction and perpendicular to the ceiling wall 14a and the bottom wall 14b (i.e., parallel to XZ plane). A plurality of heaters 16a, 16b and a plurality of conveyor rollers 24 are disposed in the heat treatment space of the furnace body 12. The heaters 16a are located above the conveyor rollers 24 and are spaced apart from each other at predetermined intervals in the conveying direction, and the heaters 16b are located below the conveyor rollers 24 and are spaced apart from each other at predetermined intervals in the conveying direction. By the heaters 16a and 16b producing heat, the space 18 in the furnace body 12 and the material in the saggar 2 are heated. As shown in FIG. 3, an opening 15a is formed in the furnace entrance wall 14c and an opening 15b is formed in the furnace exit wall 14d. The saggar 2 is carried into the heat treatment furnace 10 through the opening 15a and carried out of the heat treatment furnace 10 through the opening 15b by the conveyor (24, 26). In other words, the opening 15a serves as an entrance of the heat treatment furnace 10 and the opening 15b serves as an exit of the heat treatment furnace 10.

The conveyor (24, 26) comprises the plurality of conveyor rollers 24 and a drive unit 26. The conveyor rollers 24 convey the saggar 2. The conveyor (24, 26) carries the saggar 2 into the heat treatment furnace 10 from the opening 15a and carries the saggar 2 out of the heat treatment furnace 10 from the opening 15b. The conveyor rollers 24 are each cylindrical, and their axes extend in a direction perpendicular to the conveying direction (i.e., in Y direction). The conveyor rollers 24 all have the same diameter and are equally spaced apart from each other in the conveying direction. The conveyor rollers 24 are supported such that they are rotatable about their axes and are rotated by drive power of the drive unit 26 being transmitted thereto. The drive unit 26 is a drive unit (e.g., a motor) configured to drive the conveyor rollers 24. The drive unit 26 is connected to the conveyor rollers 24 via a power transmission mechanism. When the drive power of the drive unit 26 is transmitted to the conveyor rollers 24 via the power transmission mechanism (e.g., a sprocket-chain mechanism), the conveyor rollers 24 are thereby rotated. The drive unit 26 drives each of the conveyor rollers 24 such that the conveyor rollers 24 rotate at approximately the same speed. The drive unit 26 is controlled by a controller 28. In the present embodiment, the conveyor rollers 24 all have the same diameter, but they may have different diameters. Conveyor rollers with different diameters may be installed in the heat treatment furnace 10.

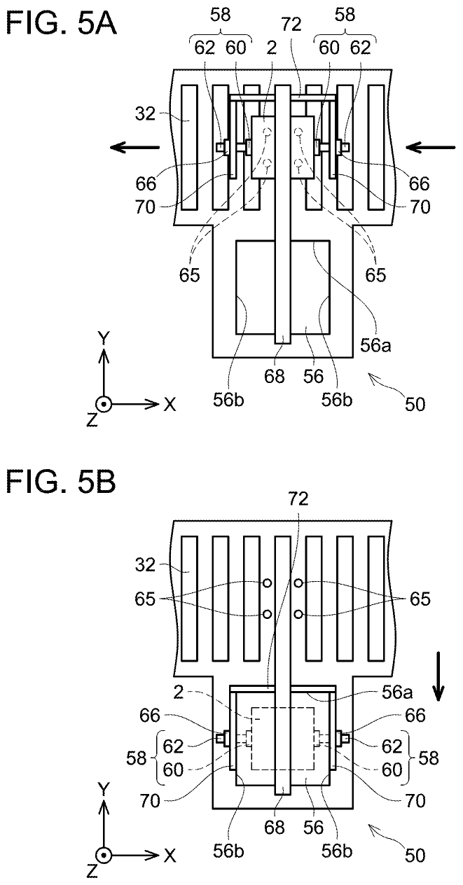

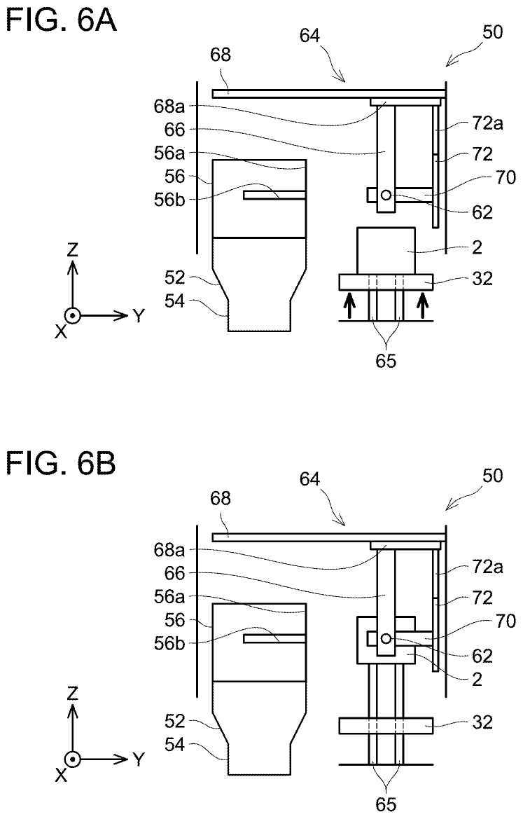

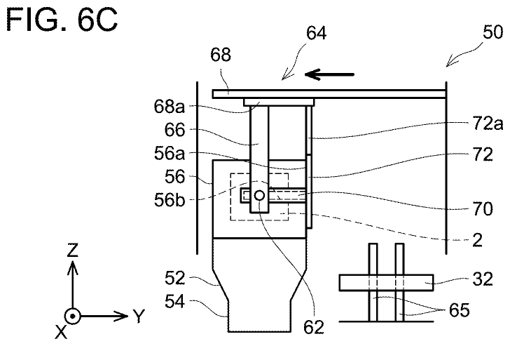

As shown in FIG. 1, the circulation and conveyor device 30 conveys the saggar 2 that exited from the exit (i.e., opening 15b) of the heat treatment furnace 10 to the entrance (i.e., opening 15a) of the heat treatment furnace 10. The circulation and conveyor device 30 comprises a plurality of conveyor rollers 32 (see FIGS. 5A, 5B and 6A to 6C) and a drive unit 34 (see FIG. 2). The conveyor rollers 32 are each cylindrical, and their axes extend in the direction perpendicular to the conveying direction. The conveyor rollers 32 all have the same diameter and are equally spaced apart from each other in the conveying direction. The conveyor rollers 32 are supported such that they are rotatable about their axes and are rotated by drive power of the drive unit 34 being transmitted thereto. The drive unit 34 is a drive unit (e.g., a motor) configured to drive the conveyor rollers 32. The drive unit 34 is connected to the conveyor rollers 32 via a power transmission mechanism. When the drive power of the drive unit 34 is transmitted to the conveyor rollers 32 via the power transmission mechanism (e.g., a sprocket-chain mechanism), the conveyor rollers 32 are thereby rotated. The drive unit 34 drives each of the conveyor rollers 32 such that the conveyor rollers 32 rotate at approximately the same speed. In the present embodiment, the conveyor rollers 32 all have the same diameter, but they may have different diameters. Conveyor rollers with different diameters may be installed on a conveying path of the circulation and conveyor device 30.

As shown in FIG. 1, the supply device 40 is disposed on the conveying path of the circulation and conveyor device 30. The supply device 40 is located upstream of the entrance of the heat treatment furnace 10, and in this embodiment, it is located between the crack detection device 46 and the entrance of the heat treatment furnace 10. The supply device 40 supplies the material (i.e., powder) into the saggar 2. The supply device 40 may have any configuration as long as it is configured to supply the powder into the saggar 2, and its specific structure is not limited. For example, the supply device 40 comprises a supply part and a leveling part. The supply part is configured to supply the powder into the saggar 2. Specifically, the supply part comprises a supply port through which the powder falls into the saggar 2 from above the saggar 2. The supply port is positioned above the center of the saggar 2 when the saggar 2 is placed inside the supply part. The supply part comprises a positioner. The positioner positions the saggar 2 conveyed into the supply part such that it is positioned below the supply port. The supply part may include a plurality of supply ports. Since the supply part supplies the powder into the saggar 2 by dropping the powder from above, once the powder has been supplied into the saggar 2 in the supply part, the top surface of the powder in the saggar 2 has a raised portion right below the supply port. The leveling part levels the powder supplied into the saggar 2 in the supply part. Specifically, the leveling part is configured to level the top surface of the powder by pressing a side surface of a flat plate against the top surface of the powder in the saggar 2. By leveling the top surface of the powder using the leveling part, the top surface of the powder in the saggar 2 becomes substantially horizontal.

The recovery apparatus 50 is disposed on the conveying path of the circulation and conveyor device 30. The recovery apparatus 50 is located downstream of the exit of the heat treatment furnace 10, and in this embodiment, it is located between the heat treatment furnace 10 and the cleaning device 44. The recovery apparatus 50 recovers the material (i.e., powder) that has been heat-treated in the heat treatment furnace 10 from the saggar 2. In the recovery apparatus 50, the conveyor rollers 32 are arranged along the conveying path from an entrance to an exit of the recovery apparatus 50 (see FIGS. 5A, 5B and 6A to 6C). The saggar 2 is conveyed in the recovery apparatus 50 by the conveyor rollers 32. As shown in FIGS. 5A to 8, the recovery apparatus 50 comprises a chute 52, a storage container 54, a hood 56, a grip unit 58, a transport device 64, a brush 74, and a suction device 76.

The chute 52 is for recovering the material in the saggar 2. The saggar 2 contains, when conveyed into the recovery apparatus 50, the material that has been heat-treated in the heat treatment furnace 10. The heat-treated material is recovered into the chute 52. The chute 52 is disposed at a position where the conveyor rollers 32 are not disposed. Specifically, the chute 52 is disposed offset from the position where the conveyor rollers 32 are disposed (hereinafter simply referred to as “conveying path”) in a direction perpendicular to the conveying direction of the saggar 2 (in this embodiment, in −Y direction). In FIGS. 5A and 5B, the chute 52 is shown offset downward from the conveying path, and in FIGS. 6A to 6C, the chute 52 is shown offset leftward from the conveying path.

As shown in FIGS. 5A, 5B and 6A to 6C, the chute 52 has a shape of a hollow quadrangular truncated pyramid, and its cross-sectional area decreases from its upper end toward its lower end. The upper outline of the chute 52 is larger than the outline of the saggar 2 when viewed from above (see FIGS. 5A and 5B). The storage container 54 is connected to the lower end of the chute 52 (see FIGS. 6A to 6C). When the saggar 2 is inverted above the chute 52, the heat-treated material in the saggar 2 passes through the chute 52 and is stored in the storage container 54.

The hood 56 covers the chute 52 from above. A lower end of the hood 56 is connected to the upper end of the chute 52, and a seal is provided between the chute 52 and the hood 56. The height dimension of the hood 56 is larger than the height dimension of the saggar 2. The hood 56 has a space that can accommodate the saggar 2 therein.

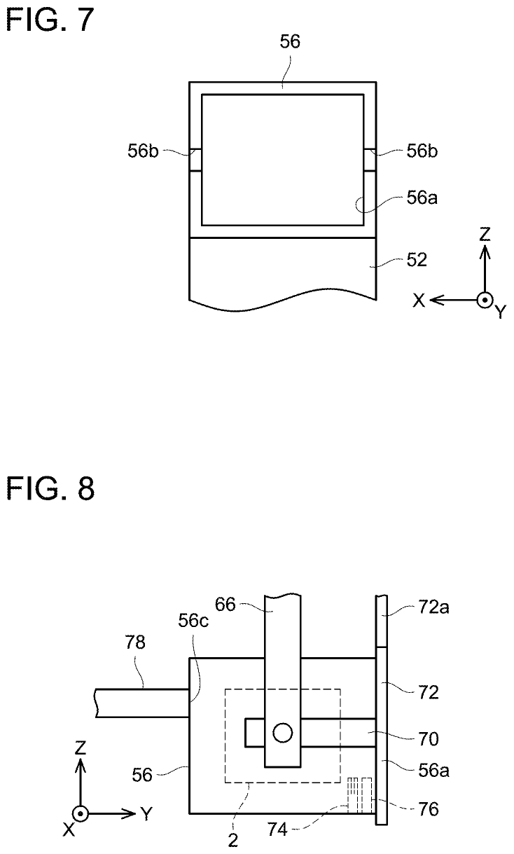

As shown in FIG. 7, an opening 56a (hereinafter also referred to as a first opening 56a) is formed in a side surface of the hood 56 that is closer to the conveying path (side surface oriented in +Y direction) among side surfaces of the hood 56 that are parallel to the conveying direction. The first opening 56a is sized to allow the saggar 2 to pass therethrough, and in this embodiment, the first opening 56a has a size that is equal to the entire side surface of the hood 56 that is closer to the conveying path. In other words, the hood 56 is devoid of the side surface closer to the conveying path. It should be noted that the first opening 56a may have any size as long as it allows the saggar 2 to pass therethrough. For example, the first opening 56a may be formed in a portion of the side surface of the hood 56 that is closer to the conveying path.

As shown in FIGS. 6A to 6C, an opening 56b (hereinafter also referred to as a second opening 56b) is formed in each of two side surfaces of the hood 56 that are perpendicular to the conveying direction (two side surfaces oriented in +X direction and −X direction, respectively). The second openings 56b are located approximately at the center of the hood 56 in its height direction as the hood 56 is viewed in X direction, and extend in Y direction. The second openings 56b are in communication with the outside at their +Y direction ends but are not communication with the outside at their −Y direction ends. The second openings 56b allow the grip unit 58 (to be described below) to move therein when the saggar 2 enters the hood 56.

As shown in FIGS. 5A, 5B and 6A to 6C, the grip unit 58 grips the saggar 2 by contacting a pair of opposing side surfaces of the saggar 2. The grip unit 58 comprises a pair of grip pieces 60 and rotation shafts 62. The grip pieces 60 are fixed to ends of the rotation shafts 62, respectively. The grip pieces 60 grip the saggar 2 by contacting the side surfaces of the saggar 2 that are perpendicular to the conveying direction. That is, the pair of grip pieces 60 is configured to be opened and closed by an actuator, which is not shown. When the pair of grip pieces 60 are closed, the saggar 2 is gripped by the pair of grip pieces 60, whereas when the pair of grip pieces 60 are opened, the saggar 2 is released from the pair of grip pieces 60. The rotation shafts 62 are each cylindrical and are supported by a support frame 66 (to be described below) so as to be rotatable about their axes. When the rotation shafts 62 rotate, the grip pieces 60 rotate together with the rotation shafts 62. When the rotation shafts 62 rotate with the grip pieces 60 gripping the saggar 2, the saggar 2 gripped by the grip pieces 60 also rotates (inverts).

In the recovery apparatus 50, the transport device 64 transports the saggar 2 between a position on the conveyor rollers 32 (the position shown in FIG. 6A, hereinafter referred to as a placement position) and a position above the chute 52 (the positions shown in FIGS. 5B and 6C, hereinafter referred to as a recovery position). The transport device 64 comprises lifting pins 65 that lift and lower the saggar 2 at the placement position, the support frame 66 that supports the rotation shafts 62 such that they are rotatable, a transport base 68a, and a guide rail 68.

The lifting pins 65 are positioned below the saggar 2 at the placement position. As shown in FIGS. 5A and 5B, the lifting pins 65 are arranged between the conveyor rollers 32. The lifting pins 65 can move upward and downward. When the lifting pins 65 move upward, they pass between the conveyor rollers 32, and then upper ends of the lifting pins 65 contact a lower surface of the saggar 2 at the placement position. In this embodiment, there are four lifting pins 65 and the four lifting pins 65 support the saggar 2 from below. The saggar 2 is lifted and lowered by the lifting pins 65 moving upward and downward. The support frame 66 is fixed to the transport base 68a. As the transport base 68a moves along the guide rail 68, the support frame 66 also moves along the guide rail 68. The guide rail 68 extends in a direction perpendicular to the conveying direction (in Y direction) above the placement position and the recovery position. As the support frame 66 moves along the guide rail 68, the grip unit 58 also moves, together with the support frame 66, along the guide rail 68 in Y direction. In other words, the saggar 2 is transported in Y direction by the grip unit 58 moving along the guide rail 68 together with the support frame 66 while gripping the saggar 2.

Here, the transportation of the saggar 2 between the placement position on the conveying path and the recovery position above the chute 52 is described. The saggar 2 is conveyed into the recovery apparatus 50 by the conveyor rollers 32. Once the saggar 2 is conveyed to the placement position in the recovery apparatus 50, the lifting pins 65 are moved upward (FIG. 6A). Then, the upper ends of the lifting pins 65 contact the lower surface of the saggar 2 and lift the saggar 2. The saggar 2 is thus separated from the conveyor rollers 32 and moved to above the conveyor rollers 32. Next, the grip pieces 60 are moved toward each other, so that they contact the side surfaces of the saggar 2. The saggar 2 is thus gripped by the pair of grip pieces 60 (FIG. 5A and FIG. 6B). Once the saggar 2 is gripped by the grip unit 58, the lifting pins 65 are moved downward. The lifting pins 65 thus separate from the saggar 2 gripped by the grip unit 58. Then, the grip unit 58 is moved laterally (in this embodiment, in −Y direction) together with the support frame 66, and the saggar 2 is brought into the hood 56 through the first opening 56a (FIG. 5B and FIG. 6C). At this time, as shown in FIG. 5B, the grip pieces 60 gripping the saggar 2 are also brought into the hood 56 together with the saggar 2. The ends of the rotation shafts 62 at which the grip pieces 60 are fixed are in the hood 56, whereas the opposite ends thereof protrude from the second openings 56b, thus are located outside the hood 56. In other words, when the saggar 2 is brought into the hood 56 through the first opening 56a, the rotation shafts 62 move laterally along the second openings 56b within the second openings 56b. As above, the saggar 2 can be brought into the hood 56 while being gripped by the grip unit 58.

Once the saggar 2 is in the hood 56, the rotation shafts 62 are rotated 180 degrees about their axes. At this time, together with the rotation shafts 62, the grip pieces 60 and the saggar 2 gripped by the grip pieces 60 are also rotated 180 degrees, as a result of which an opening of the saggar 2 is oriented downward. The chute 52 is located below the hood 56. By inverting the saggar 2 in the hood 56, the heat-treated material in the saggar 2 is recovered into the chute 52. Next, the rotation shafts 62 are rotated another 180 degrees about their axes. The saggar 2 is also rotated 180 degrees together with the rotation shafts 62, as a result of which the opening of the saggar 2 is oriented upward. At this time, the rotation shafts 62 are rotated in the opposite direction from the direction in which the saggar 2 was inverted. The rotation shafts 62 may be rotated in the same direction as the direction in which the saggar 2 was inverted. Next, the grip unit 58 is moved in +Y direction together with the support frame 66, so that the saggar 2 is brought out of the hood 56 through the first opening 56a. Once the saggar 2 is transported to above the placement position, the lifting pins 65 are moved upward until the upper ends of the lifting pins 65 contact the lower surface of the saggar 2. Then, the grip pieces 60 are moved away from each other. As a result, the saggar 2 is released from the grip unit 58, and the saggar 2 is supported on the lifting pins 65. The lifting pins 65 are then moved downward, so that the saggar 2 is placed back to the placement position on the conveyor rollers 32. The saggar 2 is then conveyed out of the recovery apparatus 50 by the conveyor rollers 32.

The transport device 64 further comprises covers 70 (hereinafter referred to as first covers 70), which are arranged perpendicular to the conveying direction, and a cover 72 (hereinafter referred to as a second cover 72), which is arranged parallel to the conveying direction.

The first covers 70 are attached to the support frame 66. The first covers 70 each have a rectangular plate shape and a size larger than the size of the second openings 56b. When the saggar 2 is in the hood 56, the first covers 70 are positioned along the second openings 56b outside the hood 56. When the saggar 2 is in the hood 56, the first covers 70 cover the second openings 56b. The first covers 70 may move toward the second openings 56b and be pressed against the second openings 56b after the saggar 2 has entered the hood 56. The second openings 56b can be closed by the first covers 70 when the saggar 2 is in the hood 56. Therefore, when the saggar 2 is inverted in the hood 56, the heat-treated material is prevented from dispersing out of the hood 56 through the second opening 56b.

The second cover 72 is positioned opposite to the hood 56 with the grip unit 58 interposed therebetween. The second cover 72 has a rectangular plate shape and a size larger than the size of the first opening 56a. The second cover 72 is fixed to a lower end of a connecting frame 72a. An upper end of the connecting frame 72a is fixed to the transport base 68a. That is, when the transport base 68a is moved, the second cover 72 is also moved together with the grip unit 58. When the saggar 2 is in the hood 56, the second cover 72 is positioned to cover the first opening 56a. The first opening 56a is closed by the second cover 72 when the saggar 2 is in the hood 56. Therefore, when the saggar 2 is inverted in the hood 56, the heat-treated material is prevented from dispersing out of the hood 56 from the first opening 56a.

As shown in FIG. 8, the brush 74 and the suction device 76 are disposed in the hood 56. Specifically, the brush 74 and the suction device 76 are disposed near the first opening 56a. The brush 74 and the suction device 76 extend in X direction. The brush 74 is positioned to contact the lower surface of the saggar 2 when the saggar 2 is brought out from the hood 56. The brush 74 removes the heat-treated material adhering to an outer surface (in particular, the lower surface) of the saggar 2 from the outer surface when the saggar 2 is brough out from the hood 56. The suction device 76 is disposed near the brush 74. The suction device 76 suctions the heat-treated material that has been removed from the saggar 2 by the brush 74. When the saggar 2 is inverted in the hood 56, the heat-treated material (i.e., powder) floats in the air in the hood 56. The floating powder in the hood 56 can adhere to the outer surface of the saggar 2. Removing the heat-treated material (i.e., powder) on the outer surface of the saggar 2 using the brush 74 and the suction device 76 allows the saggar 2 to have a reduced amount of heat-treated material on its outer surface when brought out from the hood 56. This suppresses the heat-treated material from adhering to the conveyor rollers 32 when the saggar 2 is placed back to the placement position on the conveyor rollers 32 from the recovery position.

A dust collecting duct 78 is connected to the hood 56. Specifically, a third opening 56c is formed in a side surface (side surface oriented in −Y direction) of the hood 56 opposite to the first opening 56a. The third opening 56c has a size smaller than the inner diameter of the dust collecting duct 78. The dust collecting duct 78 is in communication with the third opening 56c at one end and is connected to a suction device (not shown) at the other end. The air in the hood 56 is suctioned by the suction device through the dust collecting duct 78, and a negative pressure is thereby generated in the space within the hood 56. When the saggar 2 is inverted in the hood 56, the heat-treated material (i.e., powder) floats in the air in the hood 56. By keeping a negative pressure in the space within the hood 56, the heat-treated material is prevented from dispersing out of the hood 56.

In the recovery apparatus 50 according to the present embodiment, the chute 52 is disposed offset from the conveying path and the saggar 2 is transported to above the chute 52. Thus, the conveyor rollers 32 are not inverted together with the saggar 2 and only the saggar 2 is inverted. Therefore, it is possible to increase the inversion speed of the saggar 2, and as a result, the time required to recover the heat-treated material can be reduced.

In the present embodiment, the saggar 2 is inverted at a position offset from the conveyor rollers 32, which suppresses the heat-treated material from spreading over the conveyor rollers 32. If the heat-treated material spreads over the conveyor rollers 32, it adheres to the conveyor rollers 32 and mechanisms for driving the conveyor rollers 32 (e.g., sprockets, chains, etc.) and accumulates thereon. Such accumulating heat-treated material can adhere to the outer surface of the saggar 2 and enter the chute 52, which may cause contamination. According to the present embodiment, the amount of heat-treated material spreading over the conveying path can be reduced, and thus the risk of contamination can be reduced. Further, the heat-treated material is less likely to adhere to the conveyor rollers 32, and thus it is possible to prevent the recovery apparatus 50 from being contaminated by the heat-treated material being moved between the conveyor rollers 32 and the outer surface (lower surface) of the saggar 2.

Inverting the saggar 2 together with the conveyor rollers 32 requires a complicated mechanism for inverting them, so that many components, including the conveyor rollers 32, etc., are disposed above the chute 52. Such arrangement of many components above the chute 52 may cause a component to fall into the chute 52, and thus a substance (a component, etc.) other than the heat-treated material may enter the chute 52. According to the present embodiment, only the saggar 2 is inverted above the chute 52, and thus a substance other than the heat-treated material is less likely to enter the chute 52. In addition, since the mechanism for inverting the saggar 2 is less complicated, the inversion mechanism is less likely to malfunction. Furthermore, since the chute 52 (i.e., the position at which the saggar 2 is inverted) is disposed offset from the conveying path, there is no need to move the conveyor rollers 32 when maintenance is performed for the chute 52 and/or the inversion mechanism. Therefore, maintenance for the chute 52 and the inversion mechanism is facilitated compared to a configuration in which the saggar 2 is inverted together with the conveyor rollers 32.

Further, according to the present embodiment, the placement position and the recovery position are different, that is, the saggar 2 is gripped at the position different from the recovery position. For example, if the saggar 2 is damaged (e.g., cracked), the saggar 2 may break when pressed by the grip unit 58 to grasp the saggar 2. Even when the saggar 2 breaks by being gripped, it breaks at the position different from the recovery position, so that entry of fragments of the saggar 2 into the chute 52 can be avoided.

The cleaning device 44 cleans an inner surface of the saggar 2 after the powder has been recovered in the recovery apparatus 50. The cleaning device 44 may have any configuration as long as it is configured to clean the inner surface of the saggar 2, and its specific structure is not limited. For example, the cleaning device 44 suctions the air, etc. in the saggar 2 while removing substances adhering to the inner surface of the saggar 2 with a rotating brush. The suctioned air, etc. contains the removed substances. By cleaning the inner surface of the saggar 2 using the cleaning device 44, the powder remaining on the inner surface of the saggar 2 can be completely removed.

The crack detection device 46 inspects whether the saggar 2 is cracked or not by detecting cracks on the saggar 2. The saggar 2 is repeatedly used to heat treat the material in the heat treatment furnace 10. After the saggar 2 is used for heat treatment of the material in the heat treatment furnace 10, the crack detection device 46 inspects whether the saggar 2 is cracked or not before it is used again. The crack detection device 46 may have any configuration as long as it is configured to detect cracks on the saggar 2, and its specific configuration is not limited. For example, the crack detection device 46 may detect cracks on the saggar 2 using a laser. The crack detection device 46 may also detect cracks on the saggar 2 by filling the saggar 2 with gas and measuring the pressure in the saggar 2. If it is detected that the saggar 2 is cracked, the saggar 2 is removed from the conveying path of the circulation and conveyor device 30. If it is detected that the saggar 2 is not cracked, the saggar 2 is conveyed to the supply device 40 by the circulation and conveyor device 30.

In the present embodiment, the circulation and conveyor device 30 is a roller conveyor that conveys the saggar 2 by means of the conveyor rollers 32, but it is not limited thereto. The circulation and conveyor device may have any configuration as long as it is configured to convey the saggar 2 that exited from the exit of the heat treatment furnace 10 to the entrance of the heat treatment furnace 10. For example, the circulation and conveyor device may be a belt conveyor that conveys the saggar 2 by means of a belt. Further, in the present embodiment, the lifting pins 65 are used to lift and lower the saggar 2 during the transportation of the saggar 2 between the placement position and the recovery position, but other configurations may be used. Any configuration that is configured to move the saggar 2 between the placement position on the conveyor rollers 32 and a position above them may be used. For example, an elevator may be used to lift and lower the saggar 2.

In the present embodiment, the chute 52 of the recovery apparatus 50 is disposed offset from the conveying path vertically and laterally (in Y-direction), but is not limited thereto. The chute 52 may be disposed at any position as long as it is offset from the conveying path. For example, the chute 52 may be offset from the conveying path only laterally or only vertically. In either case as well, the conveyor rollers 32 are not inverted together with the saggar 2 and only the saggar 2 is inverted.

### Second Embodiment

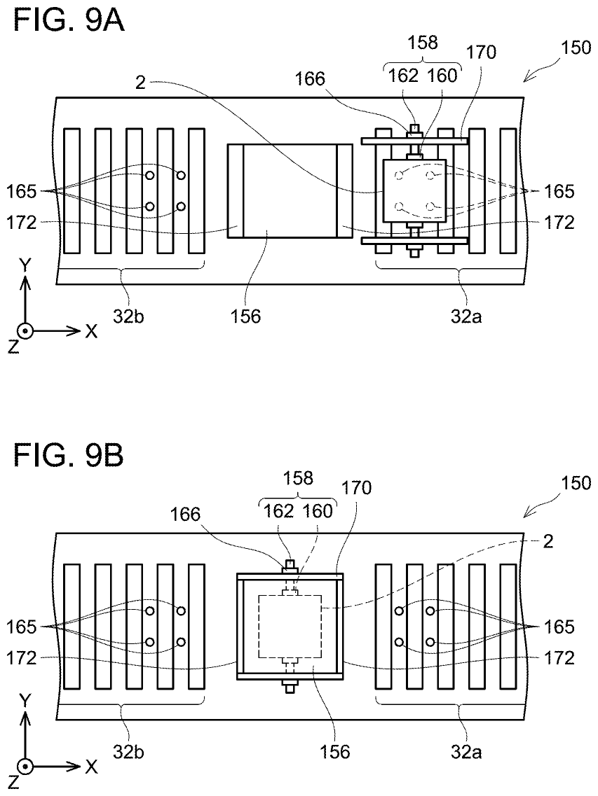

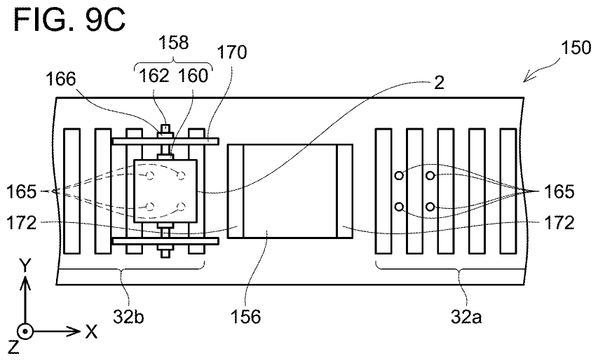

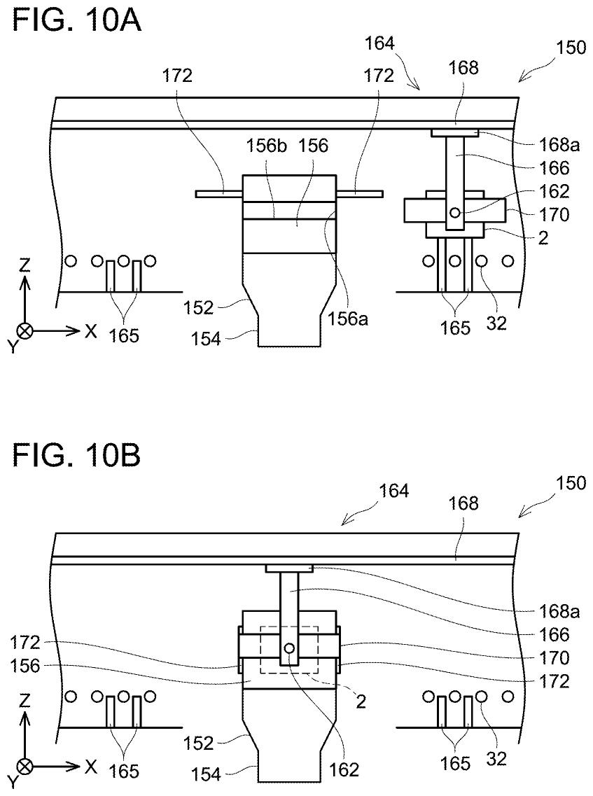

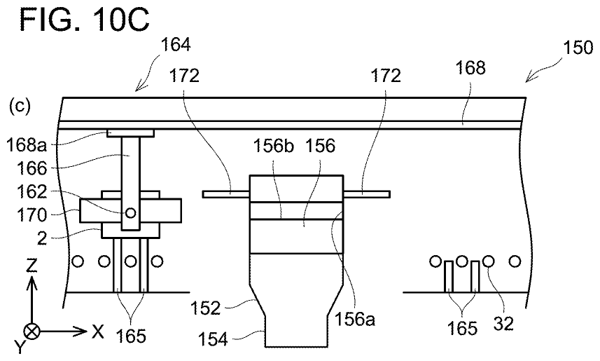

In the above embodiment, the chute 52 of the recovery apparatus 50 is disposed offset from the conveying path, but the position is not limited thereto. The chute may be disposed at any position as long as the saggar 2 can be inverted at a position where the conveyor rollers 32 are not disposed. For example, as shown in FIGS. 9A to 9C and 10A to 10C, a chute 152 of a recovery apparatus 150 may be disposed at a position on the conveying path where the conveyor rollers 32 are not disposed.

The recovery apparatus 150 comprises the chute 152, a hood 156, a grip unit 158, a transport device 164, first covers 170, and second covers 172. In this embodiment, the recovery apparatus 150 also comprises a brush 74 and a suction device 76 (not shown), but detailed description for them is omitted since they have the same configurations as those of first embodiment.

In the recovery apparatus 150, arranged on the conveying path are a plurality of conveyor rollers 32a disposed closer to an entrance of the recovery apparatus 150 (+X direction side) (hereinafter referred to as entrance-side conveyor rollers 32) and a plurality of conveyor rollers 32b disposed closer to an exit of the recovery apparatus 150 (−X direction side) (hereinafter referred to as exit-side conveyor rollers 32b). Between the entrance-side conveyor rollers 32a and the exit-side conveyor rollers 32b, there is an area where none of the conveyor rollers 32, 32a and 32b is disposed. The chute 152 is disposed in this area where none of the conveyor rollers 32, 32a, 32b is disposed between the entrance-side conveyor rollers 32a and the exit-side conveyor rollers 32b. The hood 156 is connected to an upper end of the chute 152, and a storage container 154 is connected to a lower end of the chute 152.

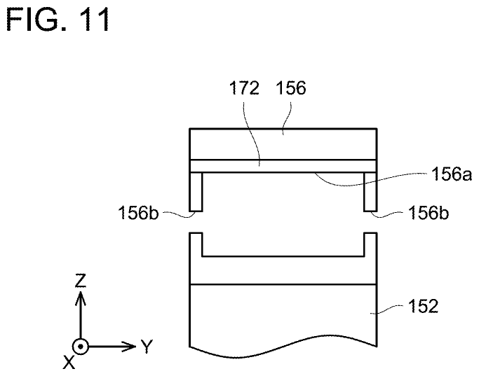

The hood 156 is attached to cover the top of the chute 152. The hood 156 has a space that can accommodate the saggar 2 therein. Openings 156a (hereinafter also referred to as first openings 156a) are formed in two side surfaces of the hood 156 that are perpendicular to the conveying direction (two side surfaces oriented in +X direction and −X direction), respectively. As shown in FIG. 11, the first openings 156a are sized to allow the saggar 2 to pass therethrough, and in this embodiment, each of the side surfaces of the hood 156 is not open at the top and bottom, and only the center portion of each side surface of the hood 156 is open. The first openings 156a may have any size as long as they can allow the saggar 2 to pass therethrough. The first openings 156a may have the same size as the size of the entire side surfaces of the hood 156 that are perpendicular to the conveying direction.

As shown in FIG. 10A to 10C, slits 156b (an example of second openings) are formed in two side surfaces of the hood 156 that are parallel to the conveying direction (two side surfaces oriented in +Y direction and −Y direction), respectively. The slits 156b are located approximately at the center position of the hood 156 in its height direction as the hood 156 is viewed in Y direction. The slits 156b extend in X direction across the entire side surfaces of the hood 156, and +Y direction and −Y direction ends of each slit 156b are both in communication with the outside. Thus, the hood 156 is divided into an upper hood portion and a lower hood portion by the first openings 156a and the slits 156b. The slits 156b allow the grip unit 158 to pass therethrough when the saggar 2 enters the hood 156.

As shown in FIGS. 9A to 9C and 10A to 10C, the grip unit 158 grips the saggar 2 by contacting the side surfaces of the saggar 2 that are parallel to the conveying direction. The grip unit 158 comprises a pair of grip pieces 160 and rotation shafts 162 to which the grip pieces 160 are fixed, respectively. The grip unit 158 differs from the grip unit 58 of the above first embodiment in that it grips the side surfaces of the saggar 2 that are parallel to the conveying direction, but the grip unit 158 is otherwise substantially the same as the grip unit 58. Therefore, a detailed description for the grip unit 158 is omitted.

The transport device 164 transports the saggar 2 between a position on the entrance-side conveyor rollers 32a (position shown in FIG. 9A), a position above the chute 152 (position shown in FIGS. 9B and 10B), and a position on the exit-side conveyor rollers 32b (position shown in FIG. 9C). That is, in this embodiment, the transport device 164 transports the saggar 2 along the conveying path.

The transport device 164 comprises lifting pins 165 that lift and lower the saggar 2, a support frame 166 that supports the rotation shafts 162 such that the rotation shafts 162 are rotatable, and a guide rail 168. The lifting pins 165 are positioned between entrance-side conveyor rollers 32a that are located near the chute 152, and are also positioned between exit-side conveyor rollers 32b that are located near the chute 152. The lifting pins 165 can move upward and downward. As the lifting pins 165 move upward, they pass between the entrance-side conveying rollers 32a and the exit-side conveyor rollers 32b, and then upper ends of the lifting pins 165 contact the lower surface of the saggar 2 located above the lifting pins 165. In this embodiment, there are eight lifting pins 165, and they lift and lower the saggar 2 by moving upward and downward. The support frame 166 is fixed to a transport base 168a. As the transport base 168a is guided and moved along the guide rail 168, the support frame 166 is also moved along the guide rail 168. The guide rail 168 extends along the conveying path (i.e., in X direction) above the conveying path. The grip unit 158 is moved in X direction together with the support frame 166 along the guide rail 168. In other words, the saggar 2 is transported in X direction as the grip unit 158 is moved together with the support frame 166 while gripping the saggar 2.

The first covers 170 are for closing the slits 156b. The first covers 170 are attached to the support frame 166. The first covers 170 each have a rectangular plate shape and a size larger than the size of the slits 156b. When the saggar 2 is in the hood 156, the first covers 170 are positioned along the slits 156b outside the hood 156. The first covers 170 cover the slits 156b when the saggar 2 is in the hood 156. The first covers 170 may be moved to be pressed against the slits 156b after the saggar 2 has entered the hood 156.

The second covers 172 are for closing the first openings 156a. The second covers 172 are attached to the side surfaces of the hood 156 that are perpendicular to the conveying direction, respectively. The second covers 172 each have a rectangular plate shape and a size larger than the size of the first openings 156a. The second covers 172 can be opened and closed, and are arranged to cover the first openings 156a when closed. Upper ends of the second covers 172 are attached to the side surfaces of the hood 156. The second covers 172 are moved (i.e., opened and closed), by a drive unit (not shown), between a position in which the second covers 172 cover the first openings 156a and a position in which the second covers 172 are perpendicular to the side surfaces of the hood 156.

Transportation of the saggar 2 in the recovery apparatus 150 is described below. In the present embodiment, the transport device 164 transports the saggar 2 along the conveying path. Once the saggar 2 is conveyed to near the chute 152 by the entrance-side conveyor rollers 32a, the lifting pins 165 are moved upward. Then, the upper ends of the lifting pins 165 contact the lower surface of the saggar 2, and the saggar 2 is lifted from the entrance-side conveyor rollers 32a. The saggar 2 is then gripped by the grip unit 158 (FIGS. 9A and 10A). Once the saggar 2 is gripped by the grip unit 158, the lifting pins 165 are moved downward and separate from the saggar 2. At this time, the second covers 172 are opened.

The grip unit 158 is moved together with the support frame 166 along the conveying path (in this embodiment, in −X direction), and the saggar 2 is brought into the hood 156 through the first opening 156a that is closer to the entrance-side conveyor rollers 32a (formed in the side surface oriented in +X direction). Once the saggar 2 is in the hood 156, the second covers 172 are closed (FIGS. 9B and 10B). At this time, as shown in FIG. 9B, the grip pieces 160 are also in the hood 156, together with the saggar 2, while gripping the saggar 2. Ends of the rotation shafts 162 to which the grip pieces 160 are fixed are positioned in the hood 156 and their opposite ends protrude from the slits 156b and are positioned outside of the hood 156. The rotation shafts 162 are rotated 180 degrees about their axes to invert the saggar 2. The heat-treated material in the saggar 2 is thereby recovered into the chute 152. The saggar 2 is inverted while the second covers 172 are closed. Therefore, the heat-treated material is prevented from dispersing out of the hood 156 from the first openings 156a. Further, when the saggar 2 is in the hood 156, the slits 156b are covered by the first covers 170. Therefore, the heat-treated material is prevented from dispersing out of the hood 156 from the slits 156b.

The rotation shafts 162 are then rotated another 180 degrees about their axes to return the saggar 2 to its original state (in which the opening of the saggar 2 is oriented upward). Then, the second covers 172 are opened. The grip unit 158 is then moved, together with the support frame 166, along the conveying path (in this embodiment, in −X direction). As a result, the saggar 2 is brought out of the hood 156 from the first opening 156a that is closer to the exit-side conveyor rollers 32b (formed in the side surface oriented in −X direction). Once the saggar 2 is transported to above the exit-side conveyor rollers 32b, the lifting pins 165 are moved upward until the upper ends of the lifting pins 165 contact the lower surface of the saggar 2. Then, the grip pieces 160 are moved away from each other, so that the saggar 2 is released from the grip unit 158. Next, the lifting pins 165 are moved downward, so that the saggar 2 is placed on the exit-side conveyor rollers 32b (FIGS. 9C and 10C). Thereafter, the saggar 2 is conveyed out of the recovery apparatus 150 by the exit-side conveyor rollers 32b.

In the present embodiment, the chute 152 is also disposed at a position where the conveyor rollers 32, 32a and 32b are not disposed. Therefore, the conveyor rollers 32 are not inverted together with the saggar 2, and only the saggar 2 is inverted.

The following are some notes on the heat treatment system 1 as described in the embodiments. The circulation and conveyor device 30 in the embodiments is an example of “conveyor”, the plurality of conveyor rollers 32 is an example of “conveyor mechanism”, the chute 52 and the storage container 54 are an example of “recovery unit”, and the rotation shafts 62 are an example of “supports”.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A heat treatment system comprising:
a heat treatment furnace including an entrance and an exit, and configured to heat-treat a material in a saggar while the saggar is conveyed from the entrance to the exit;
a conveyor configured to convey the saggar that exited from the exit of the heat treatment furnace to the entrance of the heat treatment furnace;
a recovery apparatus disposed on a conveying path of the conveyor and configured to recover the material heat-treated in the heat treatment furnace from the saggar; and
a supply device disposed on the conveying path of the conveyor between the recovery apparatus and the entrance, and configured to supply a non-heat treated material to the saggar in which the material is not accommodated,
wherein
the conveyor comprises:
a conveyor mechanism disposed along the conveying path; and
a drive unit configured to drive the conveyor mechanism,
the conveyor is configured to convey the saggar placed on the conveyor mechanism by the drive unit driving the conveyor mechanism, and
the recovery apparatus comprises:
a recovery unit disposed at a position where the conveyor mechanism is not disposed and configured to recover the material in the saggar;
a transport device configured to transport the saggar between a placement position on the conveyor mechanism and a recovery position above the recovery unit; and
an inversion mechanism configured to invert the saggar at the recovery position.

2. The heat treatment system according to claim 1, wherein
the inversion mechanism comprises a grip unit configured to grip the saggar and is configured to invert the saggar by the grip unit rotating about a rotation axis while gripping the saggar, and
the transport device is configured to transport the inversion mechanism with the grip unit gripping the saggar between the placement position on the conveyor mechanism and the recovery position above the recovery unit.

3. The heat treatment system according to claim 2, wherein
the recovery apparatus further comprises a hood covering the recovery unit from above,
the hood is sized to accommodate the saggar and the grip unit, and
the grip unit is rotatable about the rotation axis while gripping the saggar when the saggar and the grip unit are in the hood.

4. The heat treatment system according to claim 3, wherein
the grip unit comprises a pair of grip pieces configured to grip the saggar by contacting a pair of opposing side surfaces of the saggar,
the inversion mechanism further comprises a pair of supports supporting the pair of grip pieces,
one end of each support is located inside the hood and the other end thereof is located outside the hood when the saggar and the grip unit are in the hood,
the hood comprises:
a first opening defined in a first side surface; and
second openings defined in second side surfaces perpendicular to the first side surface,
the first opening allows the saggar to enter the hood from the first side surface, and
the second openings extend along an entry direction of the saggar and allow the other ends of the supports to protrude out of the hood through the second openings when the saggar is in the hood.

5. The heat treatment system according to claim 4, wherein the inversion mechanism further comprises first covers that cover the second openings when the saggar gripped by the grip unit is in the hood.

6. The heat treatment system according to claim 4, wherein
the recovery apparatus further comprises a second cover that opens and closes the first opening, and
the saggar is allowed to pass through the first opening when the second cover opens the first opening, and the saggar is prevented from passing through the first opening when the second cover closes the first opening.

7. The heat treatment system according to claim 1, wherein
an entrance and an exit of the recovery apparatus are disposed on the conveying path,
the conveyor mechanism is disposed along the conveying path from the entrance of the recovery apparatus to the exit of the recovery apparatus, and
the recovery unit is disposed offset from the conveying path.

8. The heat treatment system according to claim 7, wherein the recovery unit is disposed rightward or leftward of the conveying path and/or above the conveying path.

9. The heat treatment system according to claim 1, wherein
the conveyor mechanism comprises:
a first conveyor mechanism disposed close to an entrance of the recovery apparatus in the recovery apparatus; and
a second conveyor mechanism disposed close to an exit of the recovery apparatus in the recovery apparatus, and
the recovery unit is disposed between the first conveyor mechanism and the second conveyor mechanism.

10. The heat treatment system according to claim 1, wherein the recovery apparatus further comprises a removal device configured to remove the material adhering to an outer surface of the saggar which is located above the recovery unit.

11. The heat treatment system according to claim 3, wherein the recovery apparatus further comprises a suction device configured to suction gas in the hood.
